(19) United States
(12) Patent Application Publication
(10) Pub. No.: US 2011/0001032 A1
(43) Pub. Date: Jan. 6, 2011

(54) Pop-up lift pedestal for a television

(76) Inventor: Stewart E. Gardner, Bristol, IN (US)

Correspondence Address: R. Tracy Crump, P.O. Box 604, New Carlisle, IN, 46552, US

(21) Appl. No.: 12/803,071

(22) Filed: Jun. 18, 2010

Related U.S. Application Data
(63) Continuation-in-part of application No. 12/380,447, filed on Feb. 27, 2009.
(60) Provisional application No. 61/067,587, filed on Feb. 29, 2008.

(51) Int. Cl. F16M 11/28; F16M 11/24

(52) U.S. Cl. 248/404

(57) ABSTRACT

The lift pedestal is used to raise and lower a television or video monitor between a retracted storage position and an extended viewing position. The lift pedestal can be used as a stand alone support device or incorporated into cabinetry or a furniture enclosure. The lift pedestal includes a stationary back plate and an extensible support plate to which the television or video monitor is mounted. A pair of cabinetry drawer slides allow vertical translational movement of the support plate relative to the back plate between the retracted storage position and the extended viewing position. The drawer slides are mounted between angled sides of the back plate and support plate. The lift pedestal is actuated by a gas prop mounted to a third drawer slide. A cable and pulley operate in conjunction with the gas prop to increase the effective travel of the gas prop piston.

This is a continuation-in-part of pending U.S. patent application Ser. No. 12/380,447 filed on Feb. 27, 2009, which claims benefit of U.S. provisional patent application Ser. No. 61/067,587 filed Feb. 29, 2008.

This invention relates to an apparatus for vertically raising and lowering a television or monitor between two positions.

### BACKGROUND AND SUMMARY OF THE INVENTION

Having a television or video monitor rise and lower between a storage position within a piece of cabinetry or furniture or beneath a counter top and a viewable position above the piece of cabinetry, furniture or counter top is often advantageous for aesthetic and utilitarian reasons. A variety of complicated lift devices have been developed to raise and lower televisions and video monitors from cabinetry and other furniture pieces, but these devices have been complicated and expensive electro-mechanical devices designed for custom home theater applications.

The present invention provides a reliable and cost effective lift pedestal for raising and lowering a television or video monitor between a retracted storage position and an extended viewing position. The lift pedestal is ideal for mobile home applications and home theater applications where cost and space restrictions are a principle concern. The lift pedestal can be incorporated into any suitable piece of furniture or cabinetry. In addition the lift pedestal can be mounted directly to any wall or vertical support structure. The lift pedestal can also be used as a stand alone support device or incorporated into cabinetry or a furniture enclosure.

One embodiment of the lift pedestal of this invention includes a stationary back plate and an extensible support plate to which the television or video monitor is mounted. A pair of cabinetry drawer slides allow vertical translational movement of the support plate relative to the back plate between the retracted storage position and the extended viewing position. The drawer slides are mounted between angled sides of the back plate and support plate. The lift pedestal is actuated by a gas prop mounted to a third drawer slide. A cable and pulley operate in conjunction with the gas prop to increase the effective travel of the gas prop piston. In another embodiment, the third drawer slide, cable and pulleys are replaced by a pair of gas props mounted to a sliding bracket mounted to the base plate.

By using components, such as drawer slides and gas props, this lift pedestal eliminates the complicated electro-mechanical actuators and lifts commonly used in expensive home theater applications. The lift pedestal can be adapted to accommodate any size or weight of television or monitor. The use of the two angled drawer slides mounted between the angled sides of the back plate and the support plate ensure smooth stable transport of the television between its extended and retracted positions. The angled sides of the back plate and support plate reduce the footprint size of the lift pedestal and create a more stable lift mechanism. In both embodiments, the effective travel of the lift is maximized without having to increase the piston size or travel of the gas props employed.

These and other advantages of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a perspective view of an embodiment of the lift pedestal of this invention incorporated into a typical furniture cabinet and supporting a television in a raised position above the cabinet;

FIG. 2 is a perspective view of an embodiment of the lift pedestal of this invention incorporated into a furniture cabinet and supporting a television in a stored position within the cabinet;

FIG. 3 is a perspective view of an embodiment of the lift pedestal of this invention used as a stand alone support device showing a television in a raised position;

FIG. 4 is a perspective view of an embodiment of the lift pedestal of this invention used as a stand alone support device showing a television in a lowered position;

FIG. 5 is a front view of the lift pedestal of this invention in the extended position showing a portion of the support plate cutaway and also showing side and front views of the actuation mechanism;

FIG. 6 is a front view of the lift pedestal of this invention in an intermediate position showing a portion of the support plate cutaway and also showing side and front views of the actuation mechanism;

FIG. 7 is a front view of the lift pedestal of this invention in the retracted position showing a portion of the support plate cutaway and also showing side and front views of the actuation mechanism;

FIG. 8 is a partial exploded view of the actuation mechanism of the lift pedestal of this invention;

FIG. 9 is a partial exploded view of the upper portion of the actuation mechanism of the lift pedestal of this invention;

FIG. 10 is a partial exploded view of the lower portion of the actuation mechanism of the lift pedestal of this invention; and

FIG. 11 is a top sectional view of the lift pedestal of this invention;

FIG. 12 is a back view of a second embodiment of the lift pedestal of this invention shown in the extended position;

FIG. 13 is a back view of a second embodiment of the lift pedestal of this invention shown in the retracted position;

FIG. 14 is a partially exploded back view of a second embodiment of the lift pedestal of this invention;

FIG. 15 is a partial perspective view of a second embodiment of the lift pedestal of this invention showing the lower portion of the lift pedestal;

FIG. 16 is a partial perspective view of a second embodiment of the lift pedestal of this invention showing the upper portion of the lift pedestal;

FIG. 17 is a partial view of the slide rail and gas prop bracket; and

FIG. 18 is a sectional view of the second embodiment of the lift pedestal taken along line 18-18 of FIG. 13.

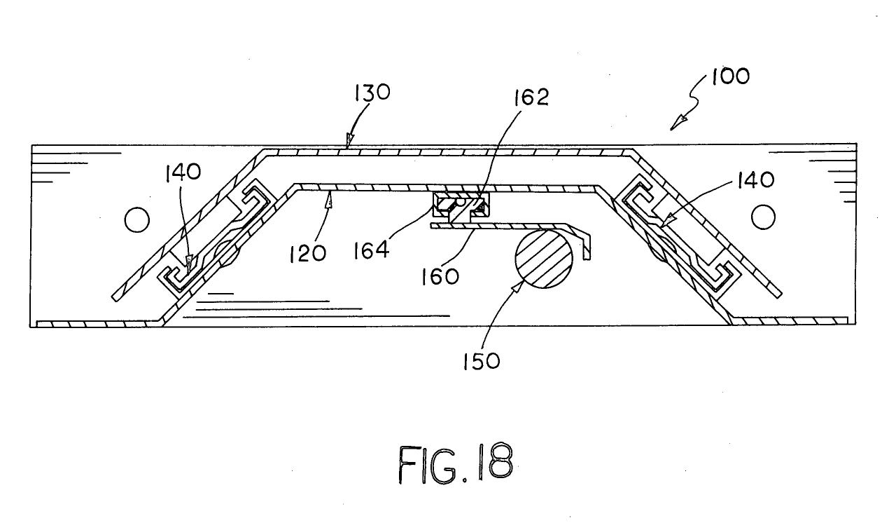

### DESCRIPTION OF THE PREFERRED EMBODIMENT

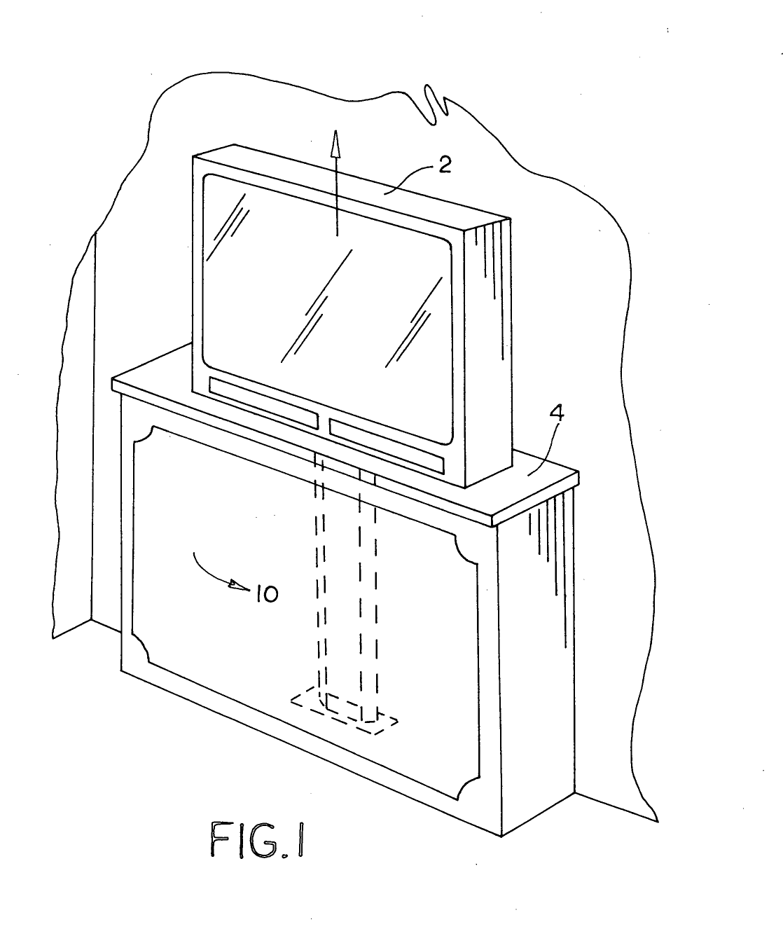

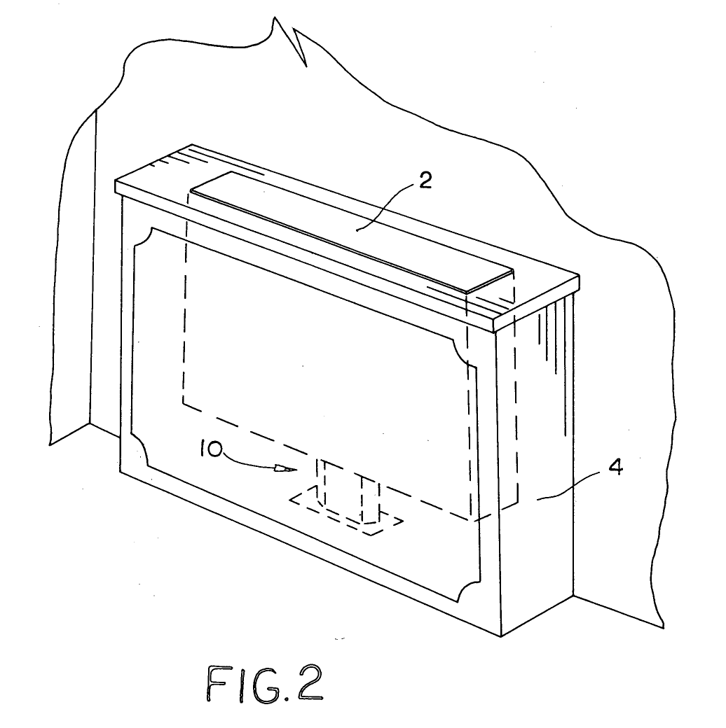

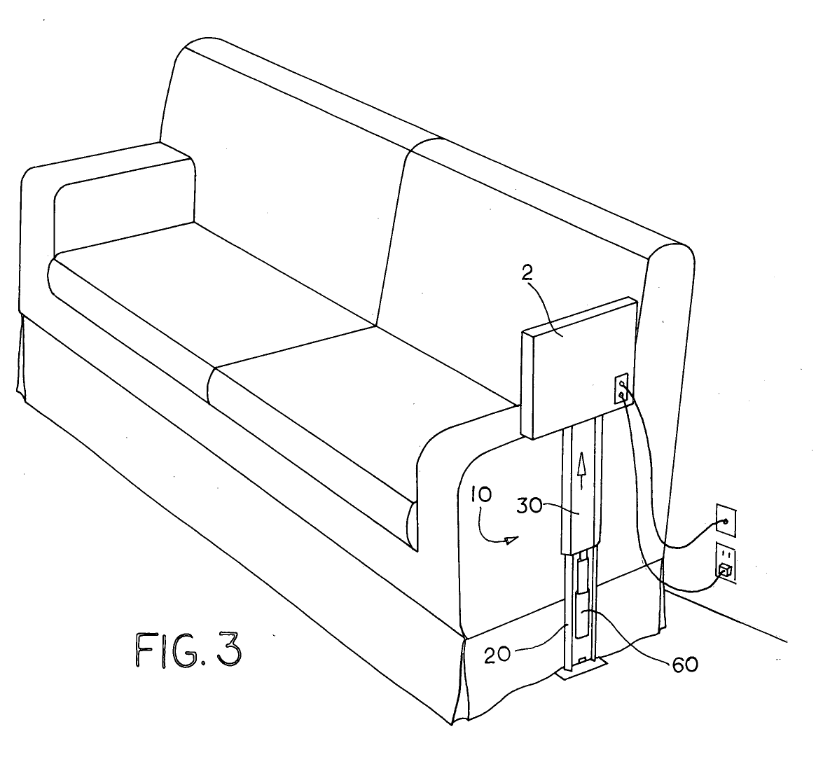

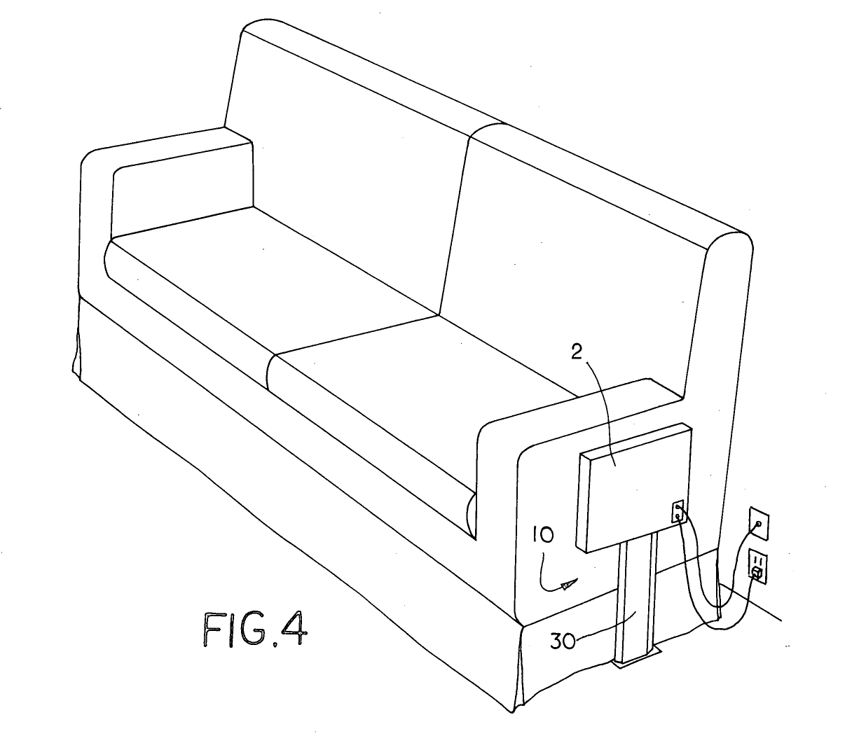

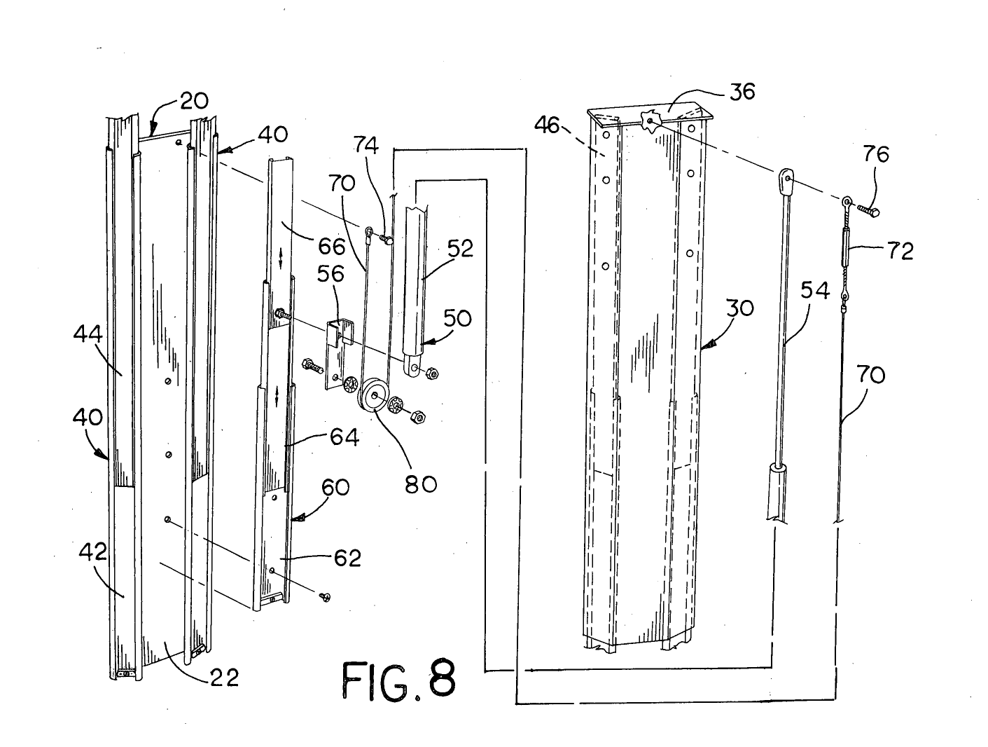

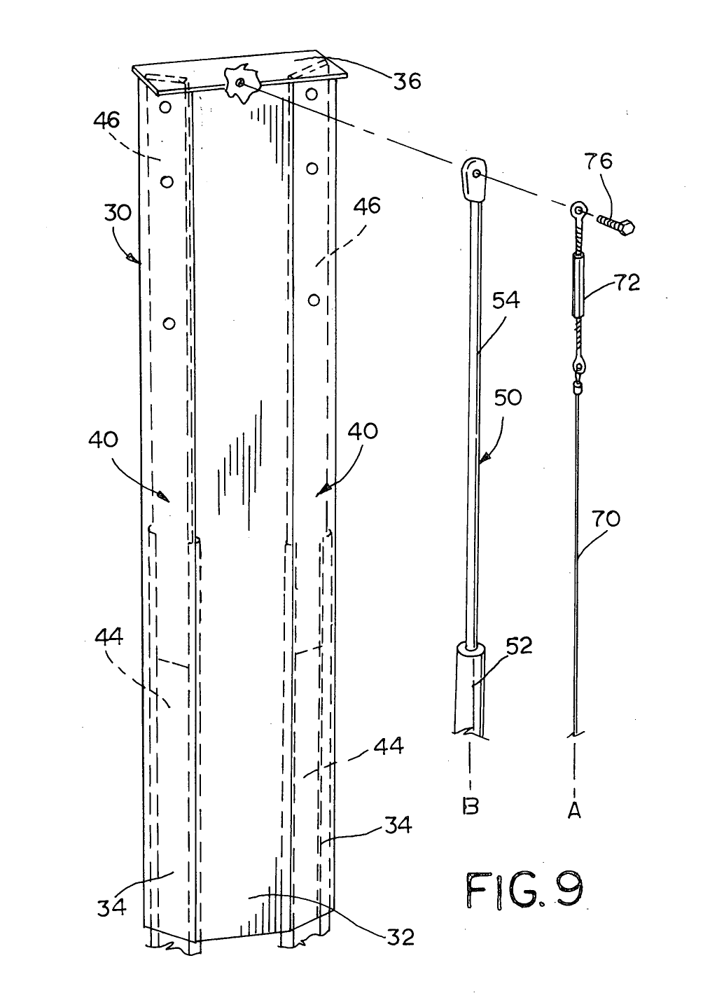

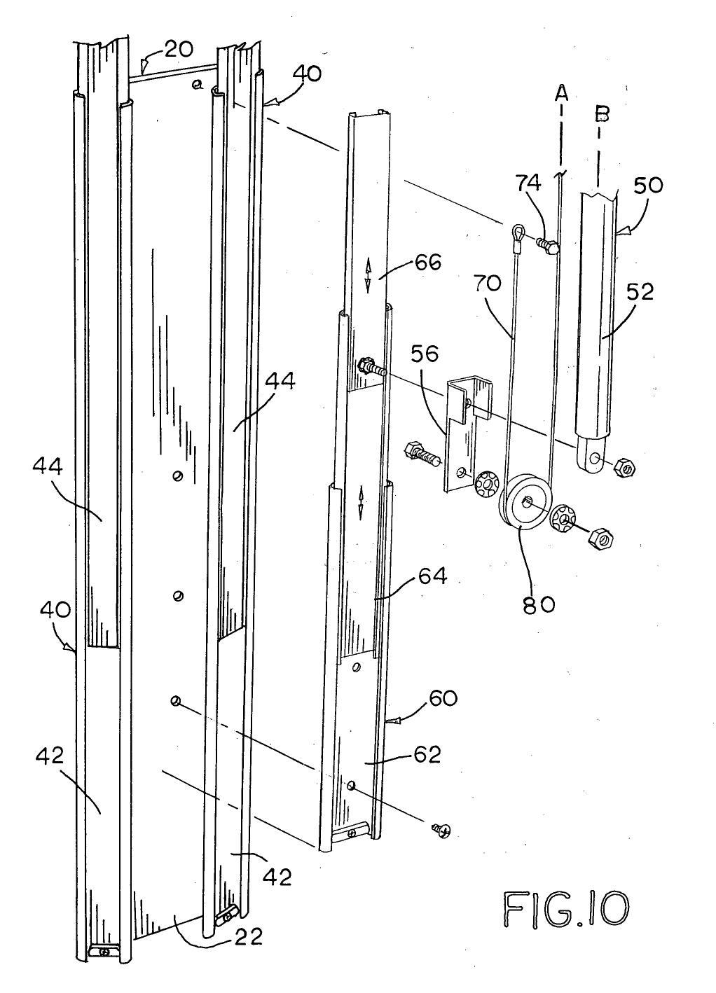

Referring now to the drawings, reference numeral 10 in FIGS. 1-11 generally designates an embodiment of the lift pedestal of this invention. Lift pedestal 10 is used to raise and lower a television, video monitor or other device between an extended or raised position and a retracted or lowered position. Lift pedestal 10 is designed to be incorporated into cabinetry or a furniture enclosure (FIGS. 1 and 2) or used as a stand alone support device (FIGS. 3 and 4). Typically, lift pedestal 10 elevates the television or monitor from the furniture enclosure into the extended position for viewing and lowers the television or monitor into the furniture enclosure into the retracted position for storage.

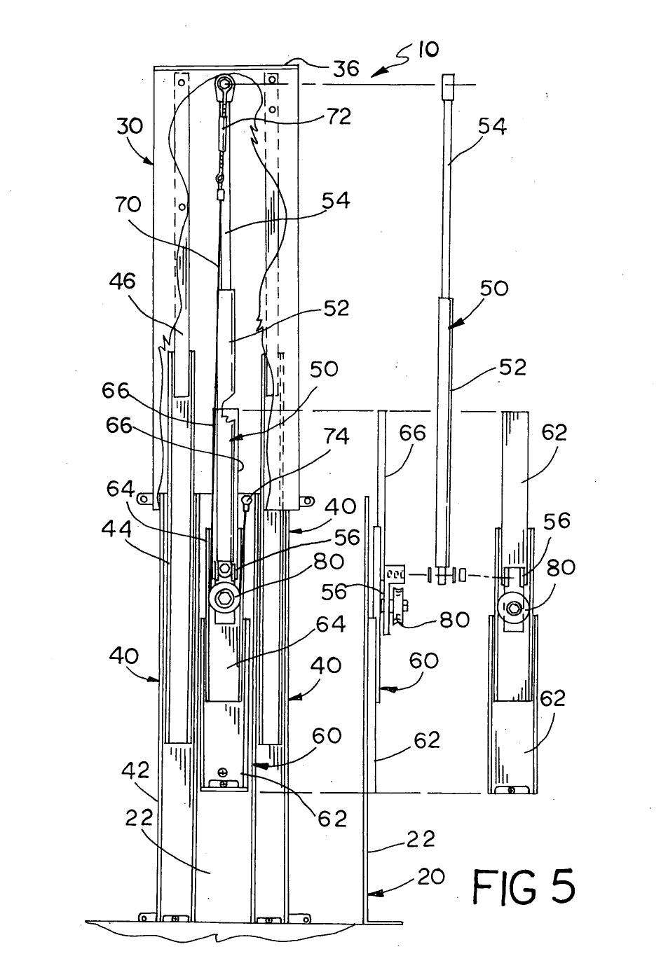

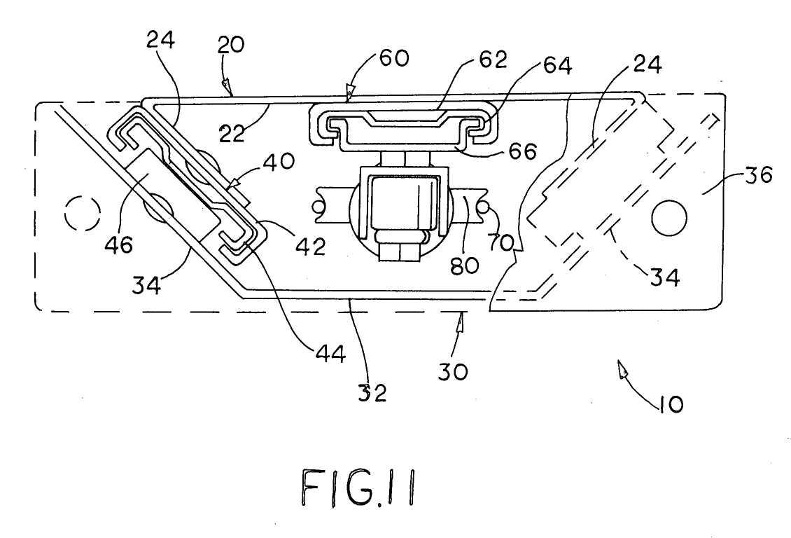

As shown in FIGS. 5-11, lift pedestal 10 includes an upright base plate 20 and an extensible television support plate 30. Base plate 20 has a flat back 22 and two angled sides 24, which converge toward each other. Support plate 30 also has a flat front 32 and two angled sides 34, which diverge away from each other. Support plate sides 34 overlie base plate sides 24. As shown in FIG. 11, base plate sides 24 and support plate sides 34 are angled at approximately 45° angles to base plate back 24 and support plate front 32. Support plate 30 is shiftable mounted to base plate 20 by two vertically oriented telescoping drawer slides 40. Drawer slides 40 allow vertical translational movement of support plate 30 relative to base plate 20 between an extended operational position and a retracted storage position. Drawer slides 40 are of conventional ball bearing design. Each drawer slide 40 includes three slide members: a proximal member 42, an intermediate member 44 and a distal member 46. The various slide members are nested within one another and extended in a telescopic manner riding on ball bearings (not shown) seated in raceways (not clearly shown) from in nested slide members. Proximal slide members 42 are connected to base plate side 24. Distal slide members 46 are mounted to support plate sides 34. Support plate 30 also includes a top mounting bracket 36. As shown, a television or monitor 2 is mounted to support plate 30 and secured to bracket 36 by fasteners 38 or other hardware. Alternatively, a television or video monitor can be mounted directly to support plate front 32 by similar fasteners and hardware.

As shown, lift pedestal 10 is actuated by a gas prop 50 mounted to a third drawer slide 60. Gas prop 50 provides the counterbalance force to actuate pedestal lift 10 between the raised operational position and the retracted storage position. Gas prop 50 is of conventional design and includes a cylinder 52 and piston rod 54. The particular gas prop used in lift pedestal 10 is selected to have the necessary counterbalance force and travel to accommodate the weight and size of the television or video monitor to be supported by the lift pedestal. Lift pedestal 10 can be modified to operate with any size and weight of television or monitor by changing the dimension of the back and cover plates and selecting the appropriate gas prop to accommodate the size and weight of the television or monitor. In addition, one skilled in the art will note that gas prop 50 can be replaced in other embodiments of this invention with an electric linear actuator or any suitable extensible drive mechanism.

As shown, drawer slide 60 is another three section drawer slide, but any suitable drawer slide may be used within the teachings of this invention. The proximal slide member 62 is mounted to the base plate back 22. A bracket 56 connects piston cylinder 52 to the distal slide member 66 of drawer slide 60. Piston rod 54 is mounted to the back of support plate front 32. A wire cable 70 and pulley 80 operate in conjunction with gas prop 50 to increase the effective travel of piston rod 54. While a wire cable is illustrated in the drawings, one skilled in the art should note that any suitable cord, rope or chain can be used within the teachings of this invention. Cable 70 is trained around pulley 80, which is mounted to bracket 56. One end of cable 70 is fixed to base plate back 22 and the other end of cable 70 terminates in a turnbuckle 72 and is fixed to the end of piston rod 54, which is secured to cover plate front 32 by a bolt or fastener 74. Turnbuckle 72 is used to manually tighten and adjust the length of cable 70 and also allows some manual adjustment of the travel of lift pedestal 10.

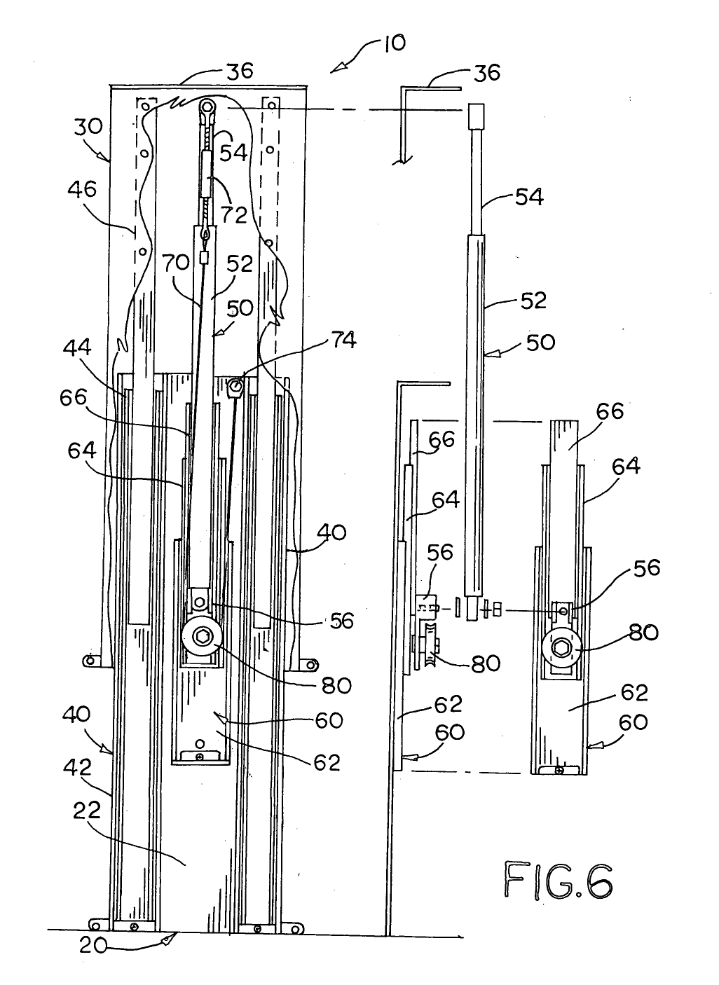

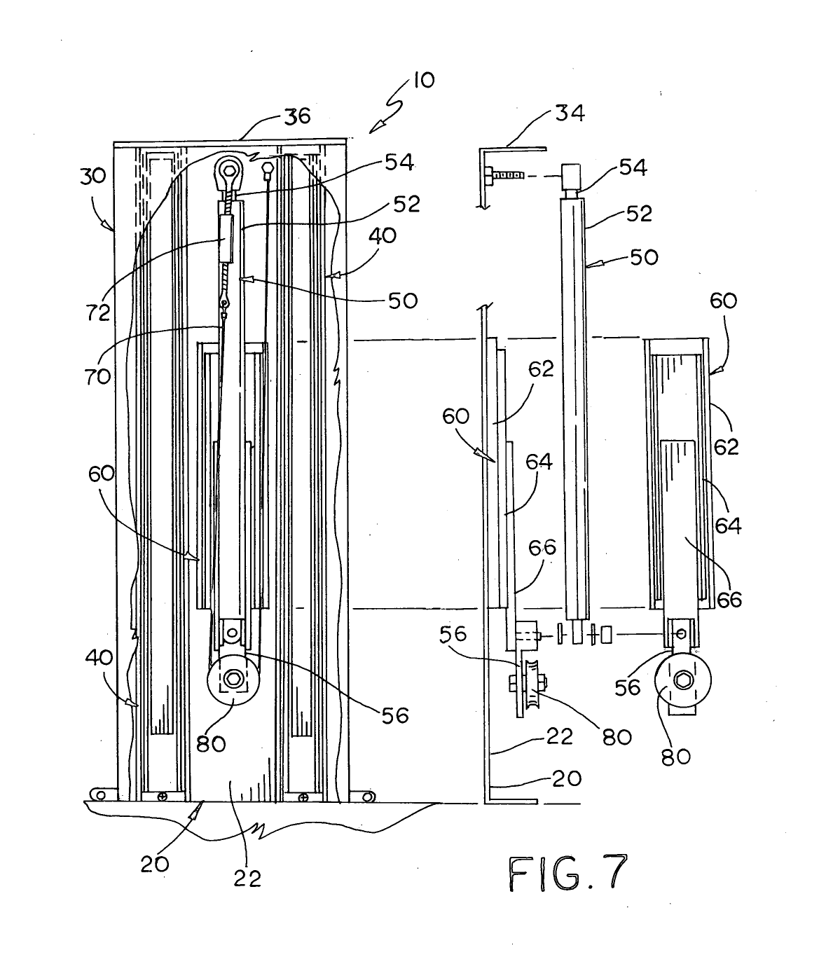

As shown in FIGS. 1-4, pedestal lift 10 shiftably supports television 2 between an extended operational position (FIGS. 1 and 3) and a retracted storage position (FIGS. 2 and 4). Gas prop 50 gives the operation of lift pedestal 10 a simple pop-up action. From the retracted storage position, downward manual pressure atop television 2 actuates gas prop 50 to lift television 2 to the raised operational position. Because gas prop 50 is mounted to drawer slide 60 and cable 70 is trained around pulley 80 with one end of the cable fixed to the end of piston rod 54 and the other end secured to base plate 20, cable 70 effectively increases the travel of gas prop 50. Extending piston rod 54 pulls cable 70, which lifts gas prop 50 and extends drawer slide 60 (FIG. 5). Retracting piston rod 54 relaxes the tension on cable 70 and allows gravity to retract drawer slide 60 (FIGS. 6 and 7).

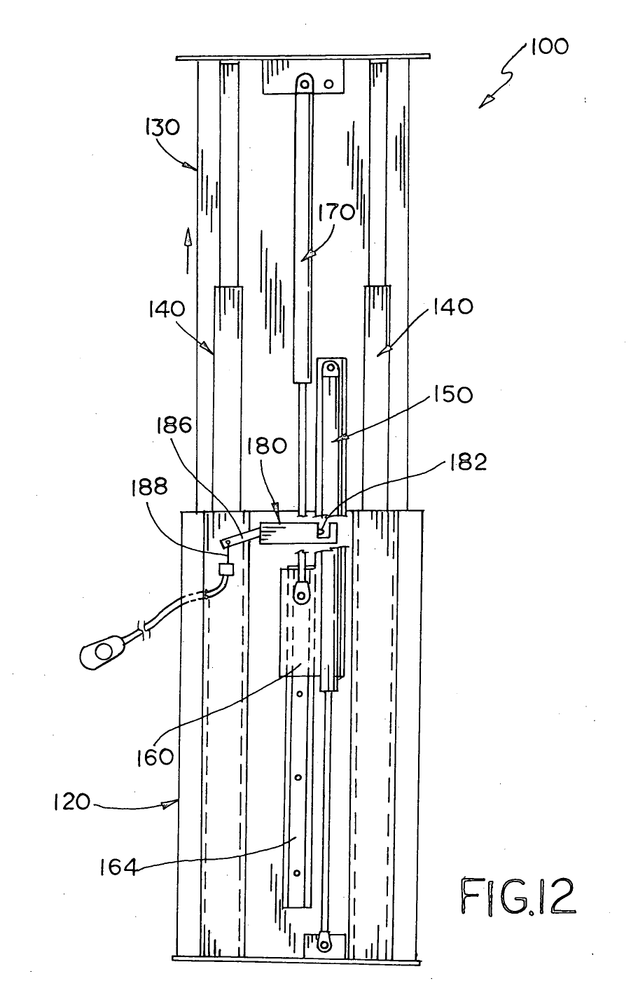

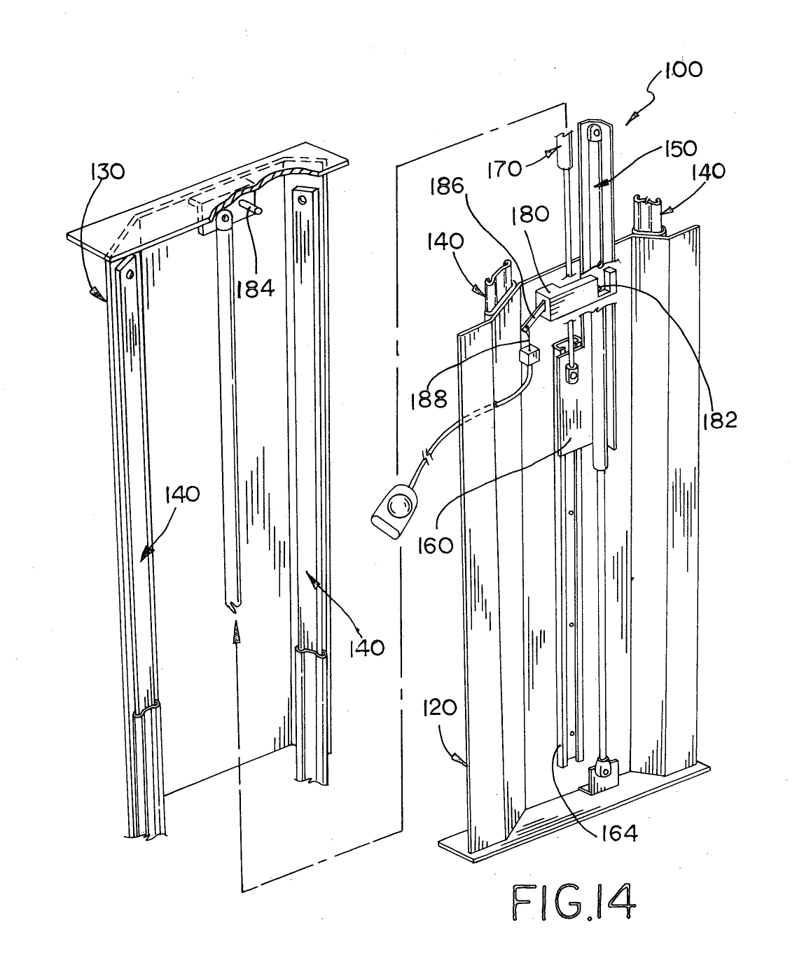

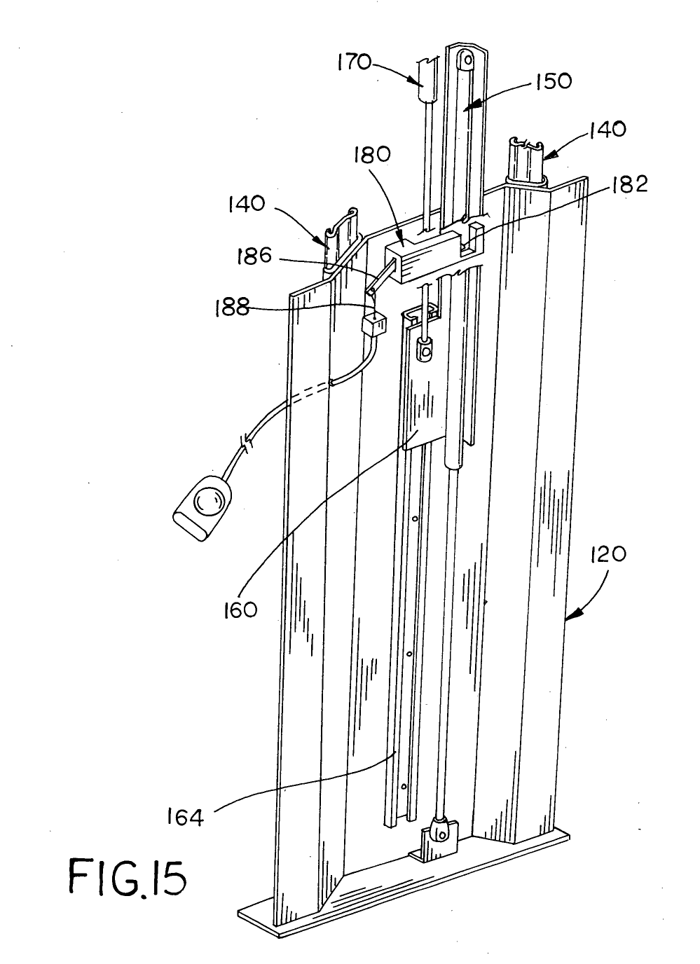

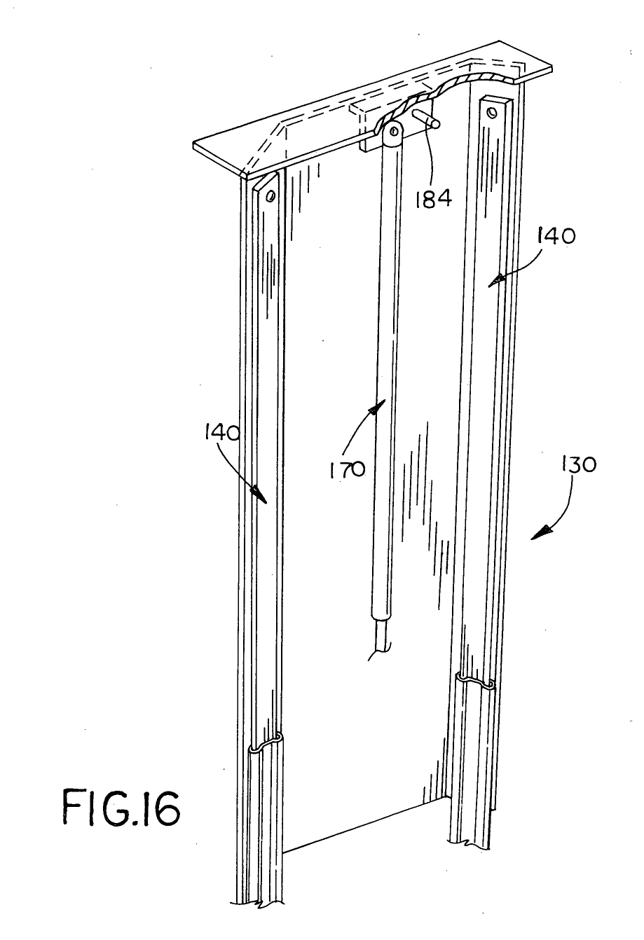

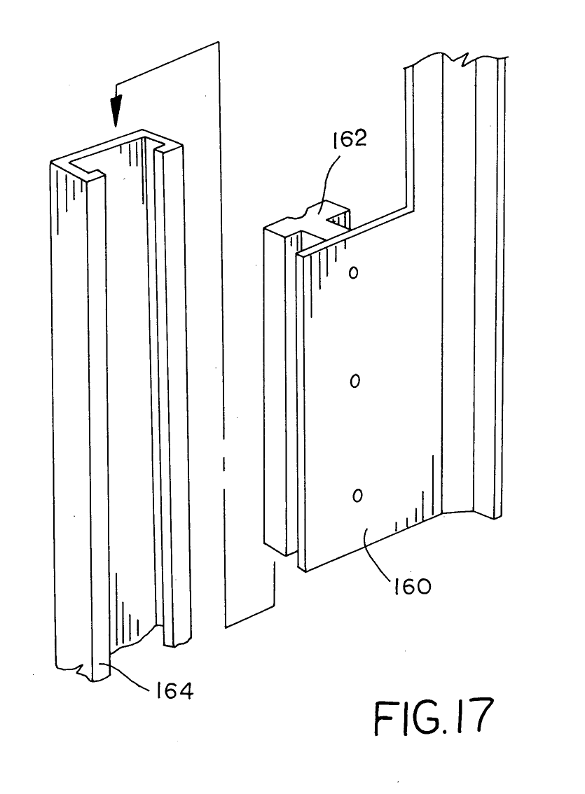

FIGS. 12-17 illustrate a second embodiment of the pedestal lift of this invention, which is designated generally as reference numeral 100. Pedestal lift 100 is identical in construction to pedestal lift 10 of FIGS. 1-11. As with the previous embodiment, pedestal lift 10 includes an extensible support plate 130 translationally mounted to base plate 120 by two vertically oriented telescoping drawer slides 140; however, the lift is actuated by two gas props 150 and 170 mounted to sliding bracket 160, which replaces the third draw slide along with the cable and pulleys. Gas props 150 and 170 provide the counterbalance force to actuate pedestal lift 100 between the raised operational position and the retracted storage position.

Again, gas props 150 and 170 are similar to gas prop 50 of pedestal lift 10 and are selected to have the necessary counterbalance force and travel to accommodate the weight and size of the television or video monitor to be supported by the lift pedestal. It should be noted that gas props 150 and 170 can be replaced in other embodiments of this invention with an electric linear actuator or any suitable extensible drive mechanism.

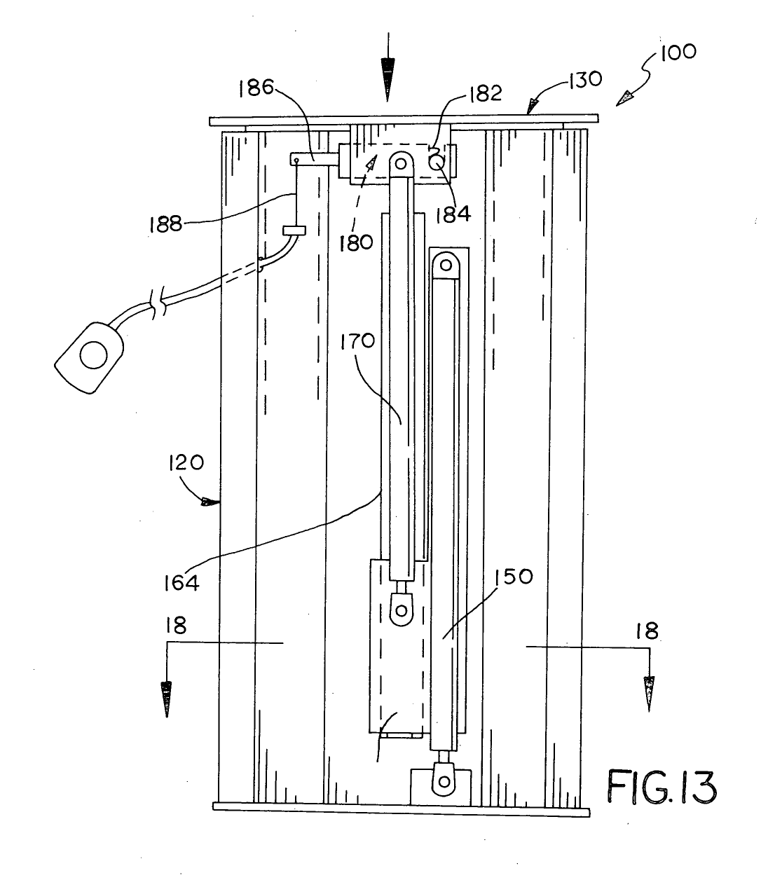

Sliding bracket 160 is mounted to a traveler 162, which slides vertically along the length of a channel 164 mounted to the back of base plate 120. Traveler 162 is formed of a low friction material, such as Teflon®, which allows the traveler to slide easily along the length of channel 164. As shown, gas prop 150 mounted to sliding bracket 160 and base plate 120 and gas prop 170 is mounted to sliding bracket 160 and support plate 130. As shown in FIGS. 12 and 13, the movement of sliding bracket 160 and the extension of gas props 150 and 170 combine to provide the desired travel for support plate 130 between the extended and retracted positions. Gas prop 150 extends to elevate sliding bracket 160 along channel 164 and gas prop 170 extends to elevate support plate 130 above base plate 120 to the fully extended position.

Pedestal lift 10 also includes a cable operated lock mechanism 180, which is used to lock support plate 130 in the retracted position. As shown, the lock mechanism includes a slide latch 182 and pin 184, which is released by a lever arm 186 attached to a cable pull 188. While a cable operated locking mechanism is illustrated, any suitable mechanical or electro-mechanical mechanism may be employed within the teachings of this invention.

One skilled in the art will note that the lift pedestal of this invention is ideal for mobile home applications and home theater applications where cost and space restrictions are principle concerns. The lift of this invention is ideal for recreational vehicle applications where floor and counter top space is critical. The lift pedestal can be incorporated into any suitable piece of furniture or cabinetry. In addition the lift pedestal can be mounted directly to any wall or vertical support structure. The lift of this invention can be manufactured using common components in the cabinetry industry, namely drawer slides and gas piston props. The use of cabinetry components allows the lift to be manufactured quickly and inexpensively and ensures simple maintenance free operation. The use of drawer slides and gas props also eliminates the complicated electro-mechanical actuators and lifts commonly used in expensive home theater applications. The lift pedestal can be adapted to accommodate any size or weight of television or monitor. The use of the two drawer slides between the back plate and the support plate allows the smooth stable transport of the television between its extended and retracted positions. The angled sides of the back plate and support plate reduce the footprint size of the lift pedestal and create a more stable lift mechanism. In one embodiment, mounting the gas prop to a third drawer slide and incorporating a cable and pulley system increases the effective travel of the gas prop piston rod without increasing the size of the gas prop. In another embodiment, the same result is accomplished by the use of two gas props in conjunction with a sliding bracket.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A lift pedestal for use with a television or video monitor comprising:
an upright back plate;
a support plate adapted for supporting the television or video monitor;
an extensible first drawer slide mounted between the back plate and support plate to permit vertical translational movement of the support plate relative to the back plate between a retracted position and an extended position;
means for actuating the support plate between the retracted position and the extended position,
the actuating means includes a bracket shiftably mounted to the back plate for vertical movement relative thereto, a first extensible drive part mounted to the bracket and the back plate to reciprocate the bracket vertically relative to the back plate, and a second extensible drive part mounted to the bracket drawer slide and the support plate to reciprocate the support plate vertically relative to the bracket.

2. The lift pedestal of claim 1 wherein the first extensible drive part and the second extensible drive part are gas props.

3. The lift pedestal of claim 1 wherein the back plate has an angled side, the support plate having an angled side overlying the angled side of the back plate.

3. The lift pedestal of claim 2 wherein the first drawer slide is disposed between the angled side of the back plate and the angled side of the support plate.

5. A lift pedestal for use with a television or video monitor comprising:
an upright back plate, the back plate has an angled side;
a support plate adapted for supporting the television or video monitor, the support plate having an angled side overlying the angled side of the back plate;
an extensible first drawer slide mounted between the back plate and support plate to permit vertical translational movement of the support plate relative to the back plate between a retracted position and an extended position, the first drawer slide is disposed between the angled side of the back plate and the angled side of the support plate;
a first extensible drive part mounted to the bracket and the back plate to reciprocate the bracket vertically relative to the back plate; and
a second extensible drive part mounted to the bracket drawer slide and the support plate to reciprocate the support plate vertically relative to the bracket,
the first piston prop and the second piston prop constituting means for actuating the support plate between the retracted position and the extended position.
